(19) United States
(12) Patent Application Publication
(10) Pub. No.: US 2013/0066885 A1
(43) Pub. Date: Mar. 14, 2013

(54) System and Method for Scoring the Popularity and Popularity Trend of an Object

(71) Applicant: Christopher S. Komuves, Chaplin, CT (US)

(72) Inventor: Christopher S. Komuves, Chaplin, CT (US)

(73) Assignee: BINGE, LLC, Clarksville, MD (US)

(21) Appl. No.: 13/550,244

(22) Filed: Jul. 16, 2012

Related U.S. Application Data
(60) Provisional application No. 61/508,419, filed on Jul. 15, 2011.

(51) Int. Cl. G06F 17/30

(52) U.S. Cl. 707/748; 707/E17.084

(57) ABSTRACT

A system and method for generating a Popularity Score for content objects in computer information systems based at least on user input. The system and method is functional in both binary (likes/dislikes) and ranked (numbered, star) rating systems. The Popularity Score utilizes the percentage of users that expressed a favorable opinion of the content object, as well as the total number of expressed user opinions to provide a more meaningful measure of the overall user likeability or appeal of the content object than systems that simply utilize user “likes” and “dislikes”. The system and method also generate Popularity Score Trends over various flexible time ranges that allow users to search, sort, and/or list content objects based on popularity over the selected date ranges.

### I. CROSS-REFERENCE TO RELATED APPLICATIONS

The present invention is related to and claims the benefit of U.S. Provisional Application No. 61/508,419 filed on Jul. 15, 2011.

### II. FIELD OF THE INVENTION

The present invention relates to the ranking of the popularity of content objects in information systems. More particularly, the present invention relates to a system and method for scoring the popularity and popularity trend of multimedia content objects interacted with by users on communications network.

### III. BACKGROUND OF THE INVENTION

Over the last several years there has been tremendous growth in the amount of digital content that is available on the Internet. It has been estimated that the total amount digital content accessible online has or will soon exceed 500 bn gigabytes (500 bn GB)—an amount that, if printed and bound into books, would stretch from Earth to Pluto 10 times. This rapid growth in digital content has been attributed to the ubiquity of the Internet, including Internet-enabled mobile phones and tablet computers, in combination with the popularity of social networking websites.

The ubiquity of the Internet and social networking websites have helped to make the expression and exchange of content both rapid and pervasive. In an effort to assist users in searching and/or sorting through the volume of available content, many websites allow content to be “ranked” or rated. However, there has been a persistent problem with providing rankings of how likeable or popular particular content objects, e.g., videos, channels, or users, are on information systems such as World Wide Web sites. Generally, available systems have allowed content objects to be voted on by users with either a binary or multi-valued scaled rating system. The typical binary systems allow users to vote their approval or “like” of an object (hereinafter referred to as “like” or “likes”), or their disapproval or “dislike” of an object (hereinafter referred to as “dislike” or “dislikes”). Optionally, such a system may also have a neutral rating choice. Other systems use a scaled rating system, often between 1 (or zero) and 5 “stars” or other named object. In either of the above systems, users can compute either a Percentage Liked (defined as the number of users who liked an object, divided by the total number of likes and dislikes), or an average rating out of all of the ratings collected for a given object.

The existing practice of merely ordering, i.e., listing or sorting, content by Percentage Liked or average rating has several limitations and does not always produce the desired ranking effect, including e.g., ranking each object relative to the overall popularity of all other objects. For example, if a particular video is liked by one person and that person is the only one who has rated the video, the “Percentage Liked” for that video would be 100%. However, if another video is liked by ninety-nine (99) people and disliked by one (1) person, the “Percentage Liked” for that video would be 99%. Clearly, the likeability or popularity of the former video is not higher than the latter. Yet, that is exactly how it would be ordered (or presented) to users if based only on the percentage of likes. Likewise, ordering content based only on the number of likes is similarly problematic, as it would fail to account for the number of dislikes for the content object.

Further, the relevance and appropriateness of content available online can be highly time sensitive. One of the aspects of online content exchange and distribution that is most liked by users is the ability to instantaneously update and promulgate content. Furthermore, content that is highly rated on one day or week may not be very relevant the following day or week. It would also be beneficial to see how a particular content object is trending over time in terms of the ranking or opinion of that object by users of the information system in which the content object appears. At present there is no system that provides a trending of content objects over time based on a weighed relative ranking that helps to ensure that the object is current and relevant.

Given the limitations associated with the above-described systems, a need still exists for a system for rating the popularity of content objects in information systems that accounts for the overall number of ratings with respect to other content objects such that the confidence of the rating is improved.

Similarly, a need also still exists for a system for rating the popularity trend of content objects in computer information systems over time that accounts for the overall number of ratings with respect to other content objects such that the confidence of the rating is improved.

### IV. SUMMARY OF THE INVENTION

The present disclosure, in at least one embodiment, provides a system for scoring content objects, including a communication module configured to allow content objects to be accessed on a communications network; a processing unit in communication with the communication module, the processing unit including a score calculation module, wherein the processing unit receives and processes user requests related to a content object, and user inputs related to the popularity of the content objects, and the score calculation module generates a score for the content objects based at least on user inputs; a database in communication with the processing unit, wherein the database stores the content objects and the score associated with the content objects.

The present disclosure, in at least another embodiment, provides a method, for scoring the popularity of content objects, including accessing, by a communication module, a content object in response to a user request on a communications network; providing, on a display, the content object to a user; receiving, by a processing unit, a user rating related to the appeal of the content object; generating, by a score calculation module, a score for the content object based at least in part on the user rating, wherein the score calculation module generates scores for both binary rating systems and multi-valued rating systems; and storing, by a database, the score and the content object.

The present disclosure, in at least another embodiment, provides a tangible, computer-readable medium having stored thereon computer-executable instructions that, when executed by a processor, cause the processor to perform operations including accessing, by a communication module, a content object in response to a user request on a communications network; providing, on a display, the content object to a user; receiving, by a processing unit, an input related to the popularity of the content object; generating, by a score calculation module, a score for the content object based at least in part on the input; and storing, by a database, the score and the content object.

### V. BRIEF DESCRIPTION OF THE DRAWINGS

FIG. 1 illustrates an example of a system for scoring the popularity and popularity trend of content objects in accordance with an embodiment of the present invention.

FIG. 2 illustrates an example of a method for scoring the popularity of content objects in accordance with an embodiment of the present invention.

FIG. 3 illustrates a table listing examples of popularity scores generated for a binary rating system in accordance with an embodiment of the present invention.

FIG. 4 illustrates a table listing examples of popularity scores generated for a multi-valued scaled rating system in accordance with an embodiment of the present invention.

FIG. 5 illustrates a table listing an example of a Popularity Score Trend in accordance with an embodiment of the present invention.

FIG. 6 illustrates an example of a screenshot of a system for scoring the popularity of content objects in accordance with the present invention.

FIG. 7 illustrates another example of a screenshot of a system in accordance with the present invention.

Given the following enabling description of the drawings, the apparatus should become evident to a person of ordinary skill in the art.

### VI. DETAILED DESCRIPTION OF THE DRAWINGS

The present disclosure, in one or more embodiments, provides a system for ranking content objects in computer information systems via communications networks. The system and method enables the most likeable, popular or well-regarded content objects to be ordered in a sensible and balanced manner that accounts for the total number of users that “Like” the objects, the total number of users that “Dislike” the objects, and the overall total number of users that rated the objects. In at least one embodiment, the system of the present invention produces a single signed, i.e., plus or minus (+/−), number score or “Popularity Score” for content objects that accounts for the total number of users that “Like” the objects, the total number of users that “Dislike” the objects, and the overall total number of users that rated the objects. In at least one embodiment, the present invention provides a method for calculating the trend of the Popularity Scores or “Popularity Score Trend” associated with a content object.

In at least one embodiment, the present invention generates a Popularity Score for content objects, e.g. videos, channels, users, reviews, and the like, in computer information systems. The Popularity Score is based on user responses or input and provides a measure of the overall user favorability, likeability or appeal of the content object for all-time. The Popularity Score, in at least some embodiments, is represented as a signed, i.e., plus or minus (+/−), number that provides an easily recognized “snapshot” of the popularity of an object. In at least one embodiment, the present invention generates a Popularity Score Trend that provides an indication of the popularity of a content object over a period of time, e.g., several hours, days, weeks, months, etc. The Popularity Score Trend may be represented in a variety of formats including, for example, numerically, graphically, and the like, to provide an easily recognized “snapshot” of the Popularity Score of an object over a period of time.

The Popularity Score and Popularity Score Trend allow users to collectively filter content such that other users are more effectively informed with respect to the popularity of the objects. For example, the Popularity Score and the Popularity Score Trend allow users to rank search results for content objects based on the popularity of the object, e.g., most likeable or popular and least likeable or popular, both for all-time, and in the recent past. The search results can then be numerically ordered, either ascending or descending, to create a list of the least and/or most popular objects. The search filters can also be used to display lists of objects that meet criteria such as being above or below certain threshold Popularity Scores or Popularity Score trends. Further, the Popularity Score trends can be used to create a graphical representation, such as a line chart, showing the trend over various periods of time, e.g., the past week or the entire life of the object.

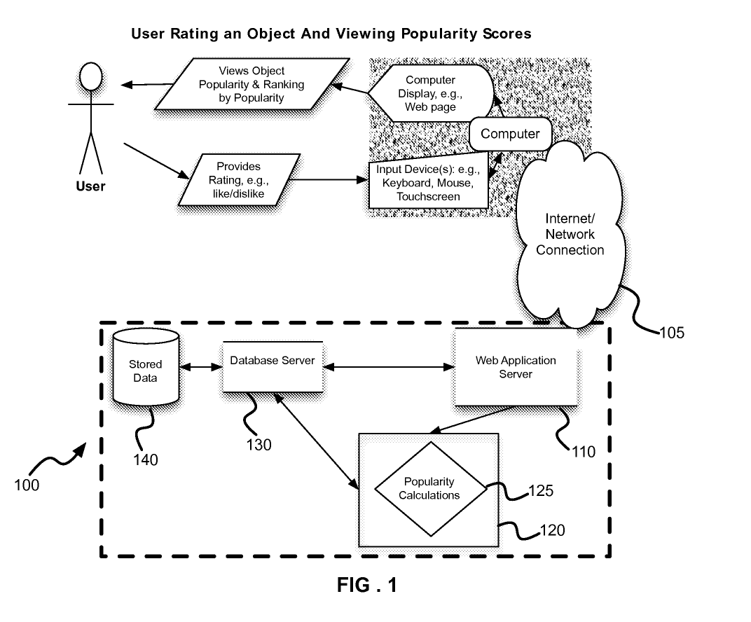

FIG. 1 illustrates an example of a system for scoring the popularity and popularity trend of content objects in accordance with an embodiment of the present invention. In at least one embodiment, the system 100 includes a web application server 110, a processing unit 120 including a score calculation module 125, a database server 130, and a database 140. The web application server 110 includes a communication module (not shown) that supports a variety of communication platforms and protocols including, e.g., Wi-Fi, cellular, local area networks (LAN), wide area networks (WAN), and the like, and allows users to access the system 100 via an Internet Protocol or other network connection 105. The web application server 110 is in communication with processing unit 120 and database server 130. Processing unit 120 receives and processes all inputs and requests provided by users with respect to content objects including scoring/rating (Likes, Dislikes, Percentage Liked, Percentage Disliked, Total Views, Trends), searches (Minimum Rating, Maximum Rating, Date Ranges), etc. The score calculation module 125 receives the processed input and generates a Popularity Score or Popularity Score Trend for the content object based on the input/request. The database server 130 allows the web application server 110 and processing unit 120 to communicate with the database 140. The database 140 stores a variety of content utilized by the system 100 including video, text, graphics, images, numbers, dates and the like. The database 140 also stores the various calculations that are generated by the score calculation module 120 (and transmitted by the processing unit 120) including the Popularity Scores, Popularity Score trends, Percentage Liked, Percentage Disliked, Total Views, etc.

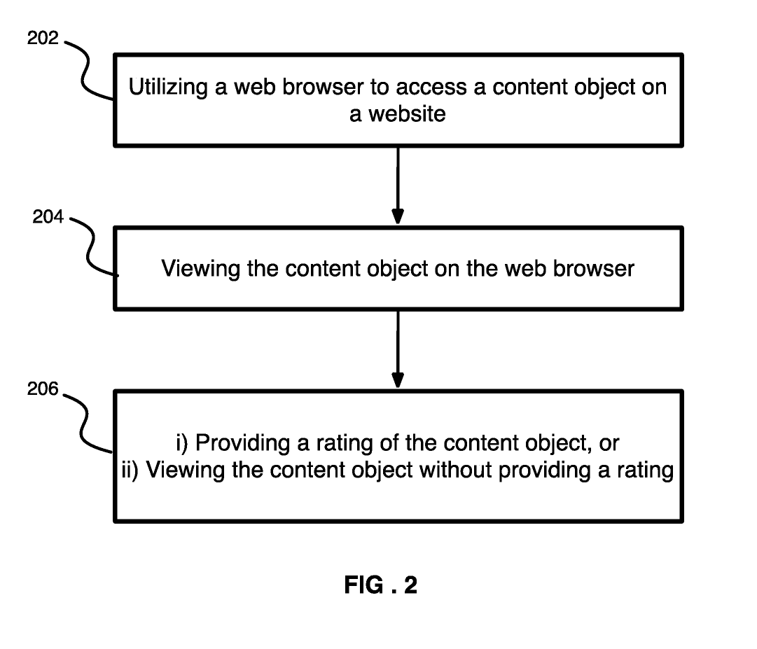

FIG. 2 illustrates an example of a method for scoring the popularity of content objects in accordance with an embodiment of the present invention as illustrated in FIG. 1. At 202, the user utilizes a web browser to access a content object on a website. At 204, the user views the content object on a web browser. At 206, the user has the option to: i) provide a rating of the content object, e.g., “Like” or “Dislike”, utilizing an input device, e.g., a keyboard, mouse, graphical user interface (GUI), touchscreen, etc., or ii) view the object without providing a rating.

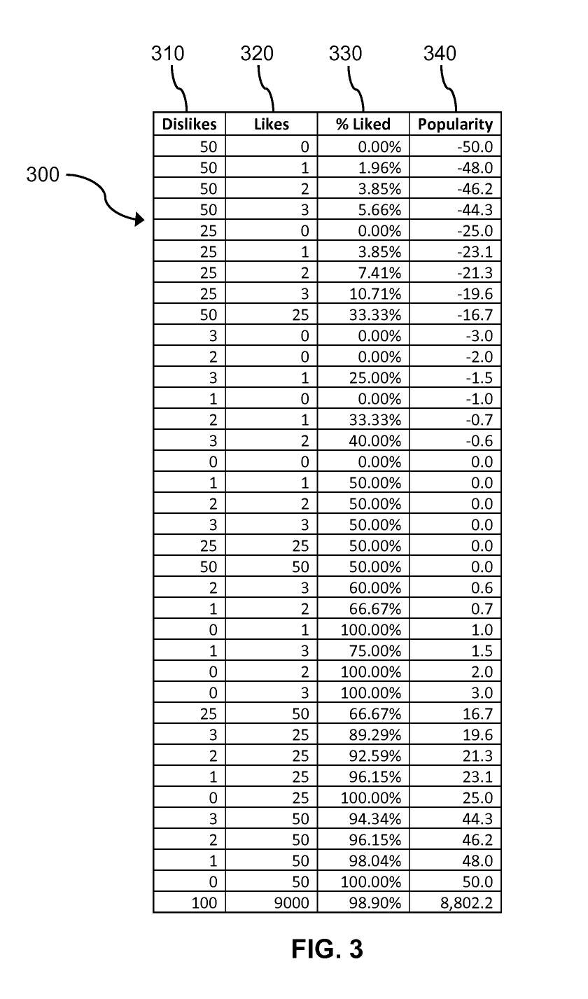

FIG. 3 illustrates examples of Popularity Scores generated for a binary rating system in accordance with an embodiment of the present invention. FIG. 3 illustrates a table 300, in row and column format, that lists examples of variables used by the score processing module 120 of system 100 (discussed above with respect to FIG. 1) to generate the Popularity Scores 340 including Dislikes 310, Likes 320, and Percentage Liked 330. The Popularity Scores 340 are generated based on the Percentage Liked 330 (percentage of users that expressed a favorable (or unfavorable) opinion of the content object). However, the total number of expressed user opinions, i.e., the number of Likes 320 plus the number of Dislikes 310, is also used to generate the Popularity Scores 340. Utilizing the total number of Likes 320 and Dislikes 310 expressed by users, in addition to the Percentage Liked 330, allows the system to provide Popularity Scores 340 that are more meaningful and have a much higher degree of confidence than systems that provide only the number of views or Percentage Liked or Disliked (without accounting for the deviation presented by too few expressed opinions).

In at least one embodiment, the system generates the popularity score in a binary rating system by utilizing the total number of user likes and the total number of user dislikes. The system calculates a Percentage Liked 330 (liked ratio) based on the total number of user likes and the total number of user ratings. When there are no likes, the popularity score will be the negative absolute value of the number of dislikes. When the Percentage Liked is greater than or equal to fifty percent (50%), the popularity score is the (total number of likes minus the total number of dislikes) multiplied by (the Percentage Liked divided by 100). When the Percentage Liked is less than fifty percent (50%), the popularity score is the (total number of likes minus the total number of dislikes) multiplied by (1 minus (Percentage Liked divided by 100)). These calculations provide a popularity score that more accurately reflects the true popularity of the content object based on user ratings. The popularity score thereby provides users with a meaningful tool for searching, sorting and viewing content objects.

Listed below is an example of a suitable pseudo-code for generating the Percentage Liked 330 in a binary rating system in accordance with the present invention. The pseudo-code is compatible with a variety of programming languages including, e.g., C, Perl, and Python, and is as follows:

```
if (($likes + $dislikes) = 0 ) {
  $likeratio = 0;
}
else {
  $likeratio = $likes / ($likes + $dislikes);
}
$likepct = sprintf(“%.2f”,($likeratio * 100));
Where $likes is the number of times this object was liked, $dislikes is the number of times this object was disliked. $likeratio is a decimal ratio and $likepct is the percent liked.
```

Listed below is an example of a suitable pseudo-code for generating the Popularity Score 340 in a binary rating system in accordance with the present invention. The pseudo-code is compatible with a variety of programming languages including, e.g., C, Perl, and Python, and is as follows:

```
if ($likes = 0) {
  $popularity = −$dislikes;
}
elsif ($likeratio > 0.5) {
  $popularity = ($likes − $dislikes) * $likeratio;
}
else {
  $popularity = (($likes − $dislikes) * (1 − $likeratio));
}
$popularity = sprintf(“%.1f”,$popularity);
Where $popularity is the popularity score of the object.
```

The pseudo-codes listed above are utilized by the score calculation module 125 of processing unit 120 (discussed above with respect to FIG. 1) to generate the popularity scores of content objects based on input received from users. Because the system 100 utilizes both the Percentage Liked and the total number of expressed user opinions, the system generates popularity scores that have a high degree of confidence and are more meaningful to users.

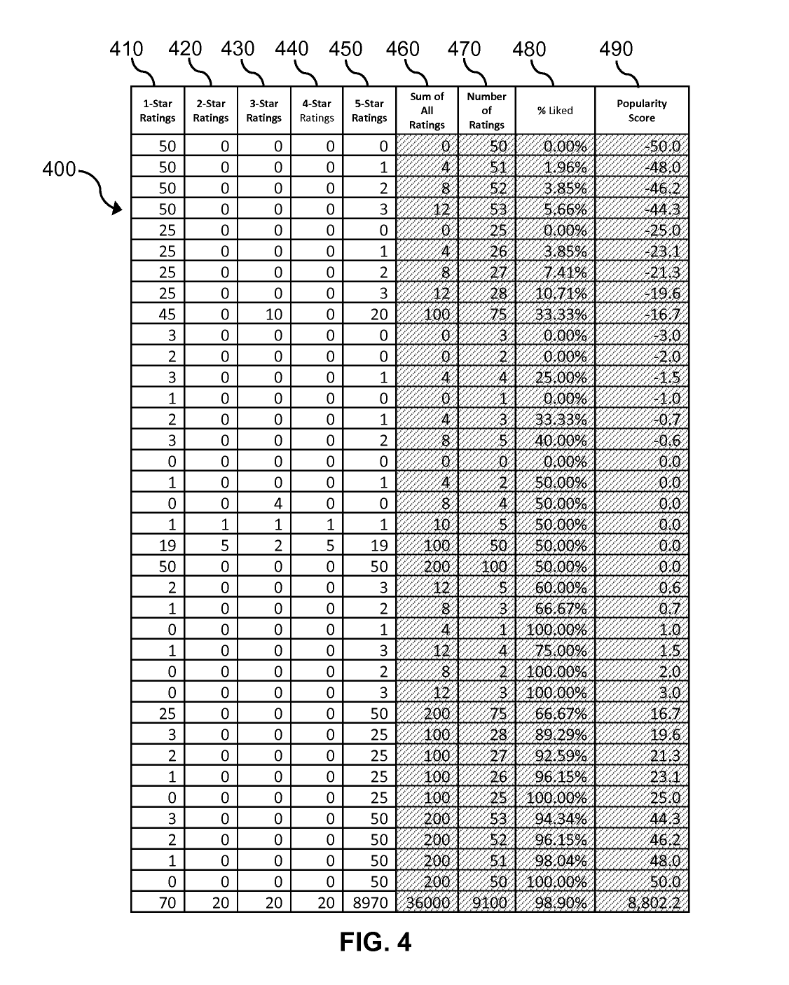

FIG. 4 illustrates examples of popularity scores generated for a multi-valued scaled rating system in accordance with an embodiment of the present invention. FIG. 4 illustrates a table 400, in rows and columns, that lists examples of variables used by the score processing module 120 of system 100 (discussed above with respect to FIG. 1) to generate the popularity scores 490 including 1-Star Ratings 410, 2-Star Ratings 420, 3-Star Ratings 430, 4-Star Ratings 440, 5-Star Ratings 450, Sum of all Ratings 460, Number of Ratings 470, Percentage Liked 480, and Popularity Score 490. The Popularity Scores 340 are generated based on the Percentage Liked 480 i.e., the percentage of users that expressed a favorable opinion of the content object; the total number of expressed user opinions or Number of Ratings 470; and the Sum of All Ratings 460.

If the content object rating scale begins with a number greater than zero, e.g., a scale that rates an object with 1-5 stars, the value of the rating provided for each object should first be adjusted to normalize the rating to another (standard) rating scale, e.g., a 0-5 or 0-10 scale. This may be accomplished by reducing the rating by the minimum rating number and typically requires reducing the score by one. For example, a 1-5 or 1-10 rating scale would be normalized to a 0-5 or 0-10 scale by reducing the rating by one. The resulting rating range would thereby be adjusted to a zero (standard) scale, i.e., zero to some other number. Since the resulting rating range would begin with zero, the range (derived by subtracting the lowest possible number score from the highest possible number rating score) would be the same as the highest possible number score. If the sum of all of the numerical ratings values for a content object is zero, i.e., no users provided a rating greater than the minimum possible rating, the Percentage Liked for that content is 0%. Otherwise, the Percentage Liked is computed by first taking the sum of all ratings for the object, divided by the number of ratings for that object. That value is then divided by the range, and the result is the Percentage Liked. The Percentage Liked is not typically assigned to objects that are rated with a ranged rating system, but it is possible to do so, as expressed above. By providing this value, the system and method of the present invention creates parity between objects rated using a ranged rating system, e.g., 1-5 stars or 1-10 stars, and objects rated using a binary rating system, e.g., dislike and like.

Listed below is an example of suitable pseudo-code for generating the Percentage Liked 480 in a multi-valued scaled rating system in accordance with the present invention. The pseudo-code is compatible with a variety of programming languages including, e.g., C, Perl, and Python, and is as follows:

```
if (scale begins with number > 0 (e.g., 1-5 stars)) {
  rating = rating −minimum_rating [for each rating score];
}
range = maximum rating;
if (sum_of_all_ratings = 0) {
  % liked = 0.00%
}
else {
  % liked = ((sum_of_all_ratings / (number_of_ratings)) /
range)
}
```

In at least one embodiment, the system generates the Popularity Score in a multi-valued rating system by utilizing the total number of each rating value submitted by the user. The system uses the total number of 1-star ratings, the total number of 2-star ratings, the total number of 3-star ratings, etc. In order to ensure consistency of ratings, the system normalizes the range of the rating scale into a range of positive integers beginning with 1 and incrementing by 1. When the Percentage Liked is zero, the popularity is the negative absolute value of the number of ratings. When the Percentage Liked is greater than or equal to fifty percent (50%), the Popularity Score will be ((the sum of all ratings divided by 2) minus the number of ratings) multiplied by (Percentage Liked/100). When the Percentage Liked is less than fifty percent (50%), the Popularity Score will be ((the sum of all ratings divided by 2) minus the number of ratings) multiplied by ((100−Percentage Liked)/100).

Listed below is an example of a suitable pseudo-code for generating the Popularity Score 490 in a multi-valued rating system in accordance with the present invention. The pseudo-code is compatible with a variety of programming languages including, e.g., C, Perl, and Python, and is as follows:

```
if (% liked = 0.00%) {
  popularity = −number_of_ratings;
}
else if (% liked >= 50%) {
  popularity = ((sum of ratings / 2) − number of ratings) * (% liked / 100)
}
else {
  popularity = ((sum of ratings / 2) − number of ratings) * (100% − (%
liked / 100))
}
```

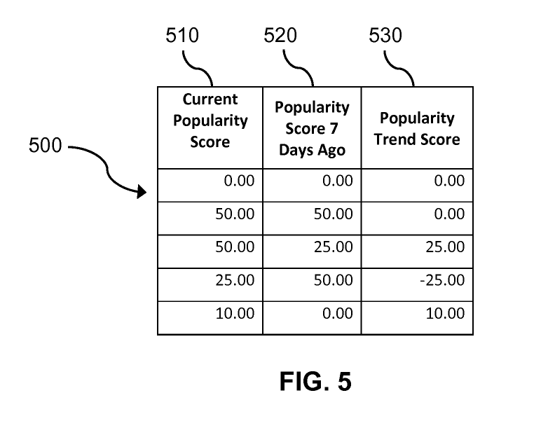

FIG. 5 illustrates a table listing an example of a Popularity Score Trend in accordance with an embodiment of the present invention. FIG. 5 illustrates a table 500, in rows and columns, listing the Popularity Trend Scores 530 for a content object. The table 500 includes the Current Popularity Score 510 and the Popularity Score 7 Days Ago 520. The score processing module 120 of system 100 (discussed above with respect to FIG. 1) system 100 generates the Popularity Trend Score 530 by determining the difference of change in popularity of the content object based on the current and previous Popularity Scores, i.e., the difference between the Current Popularity Score 510 and the previous popularity score (here Popularity Score 7 Days Ago 520). While this example uses the Popularity Score 7 Days Ago for the previous Popularity Score, a Popularity Score from any previous time frame for the content object could be used to determine the difference in Popularity Scores and generate the Popularity Trend Score 530. The Popularity Score Trend 530 may be flexibly selected over a wide time range including, e.g., several hours, days, weeks, months, specific date ranges, etc.

The Popularity Score Trend 530, in at least some embodiments, is represented as a signed, plus or minus (+/−), number that provides users with a clear representation of how the content object is trending over the selected period of time. More particularly, when the calculated Popularity Score Trend 530 is a high positive number, the Popularly Trend Score 530 tends to indicate a relatively large amount of recent positive user interest, i.e., “Likes”, in the associated content object. When the calculated Popularity Score Trend 530 is a negative number, the Popularity Score Trend tends to indicate recent negative user interest, i.e., “Dislikes”, in the associated content object. Users may utilize the Popularity Trend Score 530 to search, sort and/or filter content objects based on popularity, i.e., most/least “Liked” or “Disliked”. The search results may then be ordered in descending or ascending order to provide an easy to follow list of the most/least popular content objects. Ranking or ordering the content objects based on their Popularity Score Trends in this manner provides many useful benefits to users including, for example, listing older content objects that were once quite popular but whose popularity has faded over time in a less prominent position in search results or other displays that is more indicative of the current popularity and trend of the object.

Listed below is an example of a suitable pseudo-code for generating the Popularity Score Trend 530 in accordance with the present invention. The pseudo-code is compatible with the Perl programming language and is a follows:

$popularity_trend=$popularity−$popularitym7;
Where $popularity is the current popularity score and $popularitym7 is the popularity score that was in place at a relative point in the past (e.g., 7 days ago).

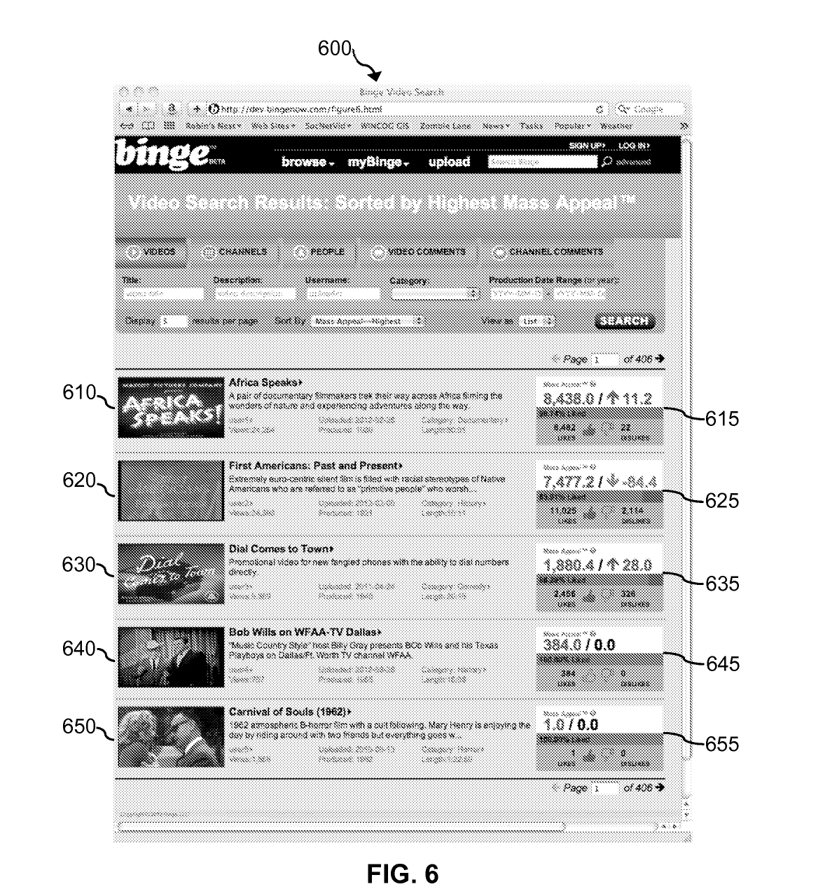

FIG. 6 illustrates an example of a screenshot of a system in accordance with the present invention. The screenshot 600 lists a series of content objects 610-650 provided in response to a search request. The screenshot 600 also includes a series of Popularity Modules 615-655 that are associated with the respective Content Objects 610-650. The Popularity Modules 615-655 provide a variety of information related to the user rating of the respective Content Objects 610-650 including the Popularity, Popularity Trend, Percentage Liked, Number of Likes, Number of Dislikes, and Total Number of Views. The screenshot 600 may also include a variety of other information related to the respective Content Objects 610-650, e.g., the user name of the uploader, upload date, length, category, descriptions, etc. The information listed in the Popularity Modules 615-655 is generated by the system and method of scoring the Popularity and Popularity Trend of Content Objects of the present invention. In this particular example, the search results have been sorted by the highest Popularity Score (called Mass Appeal). For example, Content Object 610 entitled “Africa Speaks” has the highest Popularity Score of the listed content objects. Popularity Module 615 for Content Object 610 indicates that Content Object 610 has a Popularity Score of 8,438.0, a Popularity Trend of positive 11.2, 99.74% Liked, 8,482 Likes, 22 Dislikes, and 24,254 Views. The Popularity Modules 625-655, respectively, provides the same information for the other Content Objects 620-650 listed in the search results. The Popularity Modules 615-655 thereby provide users with an easy to recognize “snapshot” of the Popularity and Popularity Trend of the Content Objects 610-650. The Popularity Modules 610-650 thereby provide a more meaningful means of searching and sorting the Content Objects 610-650. In at least one embodiment, the system and method of the present disclosure may also utilize additional considerations when generating the score. The additional considerations may include, e.g., user requests, views, comments, shares, etc. The user requests may include content searches. Shares may include the number and frequency that users share the content objects, e.g., via social media applications, email functions, and other media sharing applications. Each of these additional considerations may be used by the score calculation module to further refine the generated score.

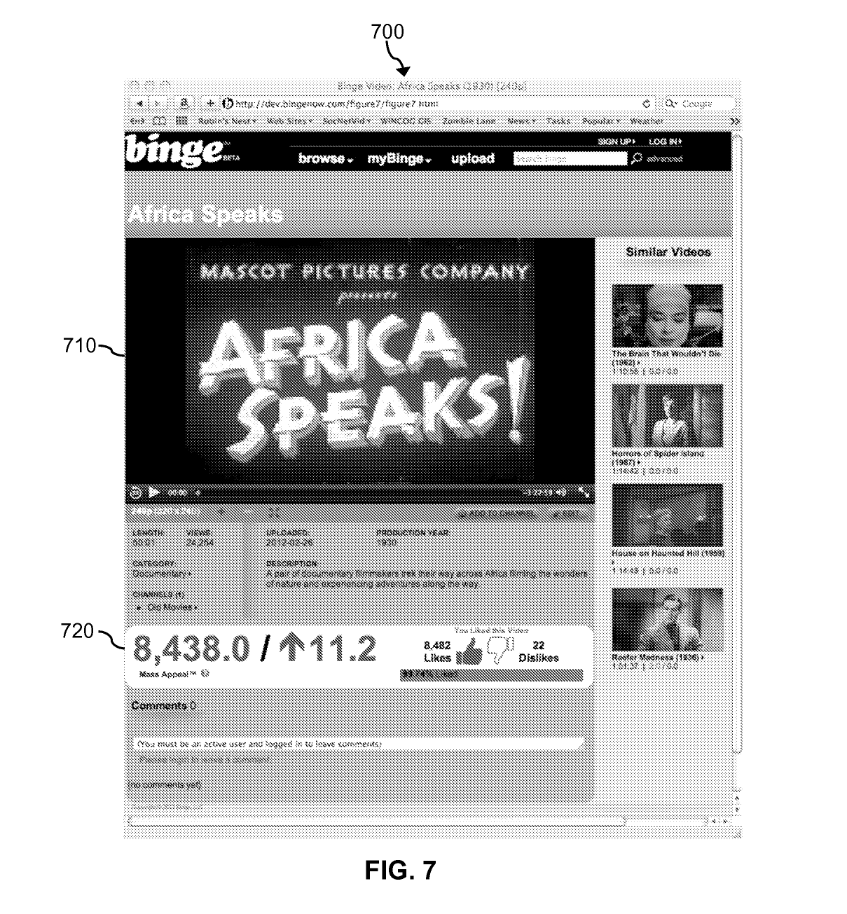

FIG. 7 illustrates another example of a screenshot of a system in accordance with the present invention. The screenshot 700 shows the Content Object 710 (video) entitled “Africa Speaks” selected from the list of Content Objects 610-650 from the search results in FIG. 6. The screenshot 700 also includes various other information related to the Content Object 710 including upload date, length, category, descriptions, video resolution, similar videos, comments, shares, etc. The screenshot 700 includes a rating interface 720 that allows users to rate the Content Object 710. The rating interface 720 may be binary such as “Like” or “Dislike” (as shown) or ranked such as 1-5 stars (not shown). The scoring system of the present invention is engaged by allowing the user to rate the Content Object 710 by selected either “Like” or “Dislike” in a binary rating system or by selecting (via an input device such as a keyboard, mouse, touchscreen, or the like) a specific star rating, e.g., 0-5, 1-5, 1-10, or the like, in a ranked rating system. Upon the user rating the Content Object 710 the scoring system of the present invention is engaged and generates scores for the Content Object 710, as discussed above with respect to FIGS. 1-5. The generated scores are stored, aggregated and presented to other users in association with the Content Object in order to provide users with an easy to recognize “snapshot” of the Popularity and Popularity Trend of the Content Objects.

The invention can take the form of an entirely hardware embodiment, an entirely software embodiment or an embodiment containing both hardware and software elements. In at least one exemplary embodiment, the invention is implemented in software that produces microcode.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache (CPU and disk) memories which provide temporary storage of at least some program code in order to reduce the number of times code must be retrieved from memory during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As will be appreciated by one of ordinary skill in the art, the present invention may be embodied as a computer implemented method, a programmed computer, a data processing system, a signal, and/or computer program. Accordingly, the present invention may take the form of a hardware embodiment, a software embodiment or an embodiment combining software and hardware aspects. Furthermore, the present invention may take the form of a computer program on a computer-usable storage medium having computer-usable program code embodied in the medium. Any suitable computer readable medium may be utilized including hard disks, CD-ROMs, optical storage devices, carrier signals/waves, DVDs, Blu-ray disks, or other storage devices.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary embodiments described above may be combined in a variety of ways with each other. Furthermore, the steps and number of the various steps illustrated in the figures may be adjusted from that shown.

It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. The accompanying drawings illustrate exemplary embodiments of the invention.

Although the present invention has been described in terms of particular exemplary embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the exemplary embodiments described above can be configured without departing from the scope and spirit of the invention. Therefore, it is to be understood that, within the scope of the appended claims, the invention may be practiced other than as specifically described herein.

We claim:

1. A system for scoring content objects, comprising:
a communication module configured to allow content objects to be accessed on a communications network;
a processing unit in communication with the communication module, the processing unit including a score calculation module, wherein:
the processing unit receives and processes user requests related to a content object, and user inputs related to the popularity of the content objects, and
the score calculation module generates a score for the content objects based at least on user inputs;
a database in communication with the processing unit, wherein the database stores the content objects and the score associated with the content objects.

2. The system according to claim 1, wherein the score calculation module generates scores for both binary rating systems and multi-valued rating systems.

3. The system according to claim 2, wherein the scores generated are standardized across all binary rating systems and all multi-valued rating systems.

4. The system according to claim 2, as applied to a binary rating system, wherein the score calculation module generates a popularity score for the content object based on a total number of user likes and a total number of user dislikes for the content object.

5. The system according to claim 2, as applied to a multi-valued rating system, wherein the score calculation module generates a popularity score for the content object based on a total number of each rating value for the content object and a rating scale used for the content object.

6. The system according to claim 1, further comprising using additional considerations to generate the score, wherein the additional considerations include at least one of: user requests, views, comments, and shares.

7. The system according to claim 2, wherein the popularity score is a signed number.

8. The system according to claim 7, wherein positive popularity scores indicate content that is more liked than disliked, and negative popularity scores indicate content that is more disliked than liked.

9. The system according to claim 1, further comprising generating a popularity trend score that represents the change in appeal of the content object over time.

10. The system according to claim 9, wherein the popularity trend score is a signed number representing the numerical difference between the current popularity score and a past popularity score.

11. The system according to claim 10, wherein the system may utilize multiple popularity trend scores which represent the changes in popularity of the content object over varying periods of time, wherein the popularity trend scores are capable of being represented both numerically and graphically.

12. The system according to claim 9, wherein higher popularity trend scores indicate content objects that are more popular in the recent past than other content objects with lower scores.

13. The system according to claim 9, wherein positive popularity scores indicate content that is more liked than disliked, and negative popularity scores indicate content that is more disliked than liked.

14. A method, for scoring the popularity of content objects, comprising:
accessing, by a communication module, a content object in response to a user request on a communications network;
providing, on a display, the content object to a user;
receiving, by a processing unit, a user rating related to the appeal of the content object;
generating, by a score calculation module, a score for the content object based at least in part on the user rating, wherein the score calculation module generates scores for both binary rating systems and multi-valued rating systems; and
storing, by a database, the score and the content object.

15. The method according to claim 14, wherein the generated scores are standardized across all rating systems, including binary or multi-valued rating systems.

16. The method according to claim 15, wherein, when utilizing a binary rating system, generating a popularity score for the content object based on a total number of user likes and a total number of user dislikes for the content object.

17. The method according to claim 15, wherein, when utilizing a multi-valued rating system, generating a popularity score for the content object based on a total number of each rating value for the content object and a rating scale used for the content object.

18. The method according to claim 15, further comprising generating a popularity trend score that represents the change in appeal of the content object over time.

19. A tangible, computer-readable medium having stored thereon computer-executable instructions that, when executed by a processor, cause the processor to perform operations comprising:
accessing, by a communication module, a content object in response to a user request on a communications network;
providing, on a display, the content object to a user;
receiving, by a processing unit, an input related to the popularity of the content object;
generating, by a score calculation module, a score for the content object based at least in part on the input; and
storing, by a database, the score and the content object.

20. The tangible, computer-readable medium according to claim 19, wherein the instructions, when executed by a processor, further cause the processor to generate scores for binary rating systems and multi-valued rating systems, wherein the generated scores are standardized across all binary rating systems and all multi-valued rating systems.
